(19) United States
(12) Patent Application Publication
(10) Pub. No.: US 2009/0063620 A1
(43) Pub. Date: Mar. 5, 2009

(54) Novel method and system for controlling access to features of a software program

(76) Inventors: Ihab M. Hanna, Redwood City, CA (US); Mate Varga, Redwood City, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/847,046

(22) Filed: Aug. 29, 2007

(51) Int. Cl. G06F 17/30; G06F 15/16

(52) U.S. Cl. 709/203; 707/9; 707/E17.005; 707/E17.008

(57) ABSTRACT

A system for controlling access to features of a software program having a software framework on a workstation, the software framework having at least one selector that is configured to access a lease package associated therewith when selected, the lease package is accessible during a subscription period, and a server communicatively coupled to the workstation, the server having a processor for: receiving a request code to access the lease package for the at least one selector, determining a subscription status for the lease package, and providing the software framework with access to the lease package if the request code to access the lease package is within the subscription period, otherwise, denying access to the lease package.

### BACKGROUND

1. Field

This disclosure relates to a novel method and system for controlling access to features of a software program.

2. General Background

Software is prevalent for residential and commercial use. Recent developments in computer technology, such as improved processor performance and large memory capacity, have accommodated the increasing complexity and size of software programs. Software developers and providers rely on sales of developed software to provide revenue. Many software programs are susceptible to piracy, which is the copying or distribution of software without returning revenue to the software developer or programmer.

### SUMMARY

The present invention provides a system and method for controlling access to features of a software program. The system having a software framework on a workstation, the software framework having at least one selector that is configured to access a lease package associated therewith when selected, the lease package is accessible during a subscription period, and a server communicatively coupled to the workstation, the server having a processor for: receiving a request code to access the lease package for the at least one selector, determining a subscription status for the lease package, and providing the software framework with access to the lease package if the request code to access the lease package is within the subscription period, otherwise, denying access to the lease package.

The method for controlling access to features of a software program includes receiving a request code to access a lease package for at least one selector of a software framework, the at least one selector is configured to access the lease package associated therewith when selected, the lease package is accessible during a subscription period, determining subscription status for the lease package, and providing the software framework with access to the lease package if the request code to access the lease package is within the subscription period, otherwise, denying access to the lease package.

The present invention also provides a machine-readable medium with instructions for a software framework and a plurality of selectors, which when read by a processor, cause the machine to perform operations comprising sending, to a remote server, a request code to access a lease package for one of the plurality of selectors, and receiving, from the remote server, access to the lease package, if the request code to access the lease package is within the subscription period, otherwise, denying access to the lease package.

### DRAWINGS

The above-mentioned features and objects of the present disclosure will become more apparent with reference to the following description taken in conjunction with the accompanying drawings wherein like reference numerals denote like elements and in which:

FIG. 1 is an exemplary subscription system for a software program according to one embodiment of the present invention.

FIG. 2 illustrates a software program with a software framework according to one embodiment of the present invention.

FIG. 3 is an exemplary subscription system, demonstrating interaction between a client server and a remote server, according to one embodiment of the present invention.

FIG. 4 illustrates the interactions between a workstation and a client server, according to one embodiment of the present invention.

FIG. 5 illustrates a client server with a plurality of workstations, according to one embodiment of the present invention.

FIG. 6 is an exemplary subscription system for a plurality of workstations according to one embodiment of the present invention.

FIG. 7 is a block diagram illustrating a module system for a subscription system, according to one embodiment of the present invention.

FIG. 8 is a block diagram illustrating components of a software program, according to one embodiment of the present invention.

FIG. 9 is a block diagram illustrating a software framework interfacing with a subscription plug-in, according to one embodiment of the present invention.

FIG. 10 is a block diagram illustrating a command system for the software program, according to one embodiment of the present invention.

FIG. 11 illustrates a command syntax for the software program, according to one embodiment of the present invention.

### DETAILED DESCRIPTION

Reference will now be made to a preferred embodiment, examples of which are illustrated in the accompanying drawings. While the invention will be described in conjunction with the preferred embodiments, it will be understood that these embodiments are not intended to limit the scope of the invention. On the contrary, the invention is intended to cover alternatives, modifications, and equivalents, which may be included within the spirit and scope of the invention as defined by the appended claims. As such, the description of the embodiments that follow are for purposes of illustration and not limitation.

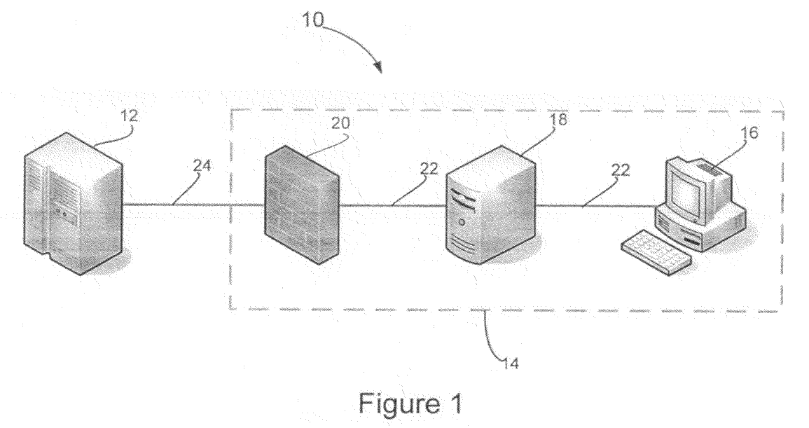

FIG. 1 is an exemplary subscription system 10 for a software program according to one embodiment of the present invention. Subscription system 10 may include a remote server 12 and a client system 14. Remote server 12 may be provided by a subscription provider. Remote server 12 may be configured to provide client system 14 with a lease package that, according to a subscription, allows the client system 14 to operate certain features of the software program. Remote server 12 may be coupled to the client system 14 through a network 24. Network 24 may include, but not limited to, a wide-area network such as the Internet, a local area network, such as an Ethernet, and a wireless network, such as a wireless local area network.

According to an illustrative embodiment, the client system 14 may include a client server 18 coupled to a workstation 16 by a network 22. In another embodiment, the client system 14 may further include a firewall 20. Network 22 may include, but not limited to, a wide-area network such as an Internet, a local area network, such as an Ethernet, and a wireless network, such as a wireless local area network. While the embodiment illustrated in FIG. 1 shows workstation 16 and client server 18, it is understood by a person skilled in the art that workstation 16 may be used as a server, and as such, may not require a separate client server 18. The workstation 16 may be configured to receive from remote server 12 a lease package that, according to a subscription, allows the workstation 16 to operate certain features of the software program.

The software program is generally stored in a storage device and is executed by a processor. The software program can be implemented using hardware, software or a combination of hardware and software. The storage device can be a machine-readable medium, which may be any mechanism that provides (i.e. stores and/or transmits) information in a form readable by the processor of the workstation 16. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The storage device may include a database that can be used to store, arrange and retrieve data from the storage device.

The machine-readable medium may provide instructions for a software framework with a plurality of selectors, which when read by a processor, cause the machine to perform operations comprising sending, to a remote server, a request code to access a lease package for one of the plurality of selectors, and receiving, from the remote server, access to the lease package, if the request code to access the lease package is within the subscription period, otherwise, denying access to the lease package. The plurality of selectors may be adapted to access a lease package associated therewith when selected, and the lease package may be accessible during a subscription period.

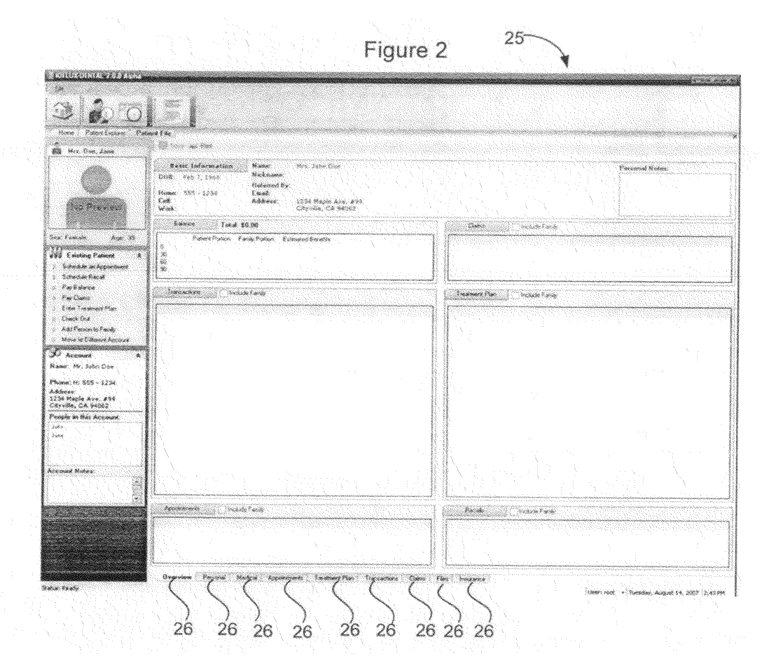

According to one embodiment of the present invention, the software program is generally a software framework 25 having predetermined basic features that allows the client to interface with the remote server 12. As shown in FIG. 2, the software framework 25 may include at least one selector 26. The at least one selector 26 may be a link, icon, button, or image that a user can select to access additional features of the software program. In one embodiment, selector 26 may be associated with a lease package. The lease package may include one or more subscription plug-ins that provide additional features to the software program.

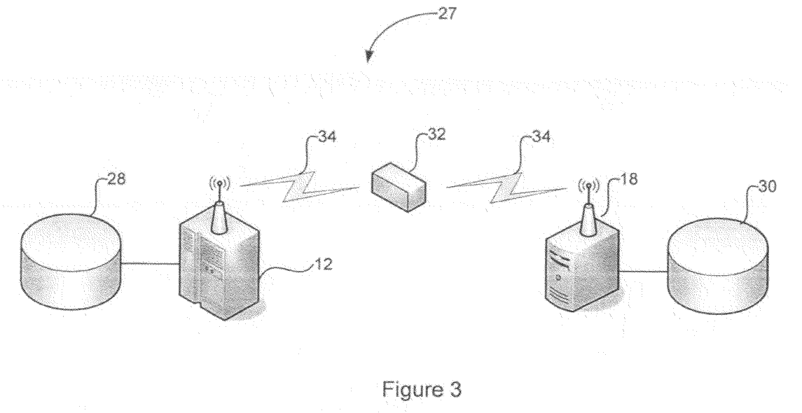

FIG. 3 is an exemplary subscription system 27, demonstrating interaction between client server 18 and remote server 12, according to one embodiment of the present invention. The subscription system 27 may include a remote database 28, remote server 12, client server 18 and a client database 30. The remote database 28 may store, arrange and retrieve records of clients subscribing to a lease package 32. The remote database 28 may also store, arrange and retrieve at least one lease package 32 for operating certain features of the software program. The client database 30 may store, arrange and retrieve data for the software program, such as but not limited to, subscription plug-ins and lease packages 32.

In operation, the remote server 12: (a) receives a request code to access the lease package 32 for at least one selector 26 of the software framework 25 from client server 18 via network 34, the at least one selector 26 is configured to access the lease package 32 associated therewith when selected, the lease package 32 is accessible during a subscription period, (b) determines subscription status for the lease package 32, and (c) provides the software framework 25 with access to the lease package 32 if the request code to access the lease package 32 is within the subscription period, otherwise, denying access to the lease package 32.

It can be envisioned that access to lease package 32 may include at least one of retrieval and execution of lease package 32. The subscription period where lease package 32 is accessible may be a retrieval period and/or an execution period. For example, retrieval of lease package 32 may take place during a retrieval period of one year, while execution of lease package 32 may take place during an execution period of thirty days, wherein the execution period occurs within the retrieval period. According to one embodiment, workstation 16 may retrieve lease package 32 from the remote server 12 during the retrieval period. Once, lease package 32 is retrieved, it may be stored on client database 30 and is available for execution during the execution period. According to an embodiment, the execution period may be defined by a predetermined period of time. According to another embodiment, the execution period may be defined by a predetermined number of executions of lease package 32.

According to an embodiment, lease package 32 may include program content and security content. Program content may comprise executable code, plug-ins, libraries, files, programming routines, scripts, images, and other data that may be accessed during the subscription period to provide additional features to the software program. For example, the program content of lease package 32 allows the software program to perform certain functions beyond those provided within the software framework 25. In one embodiment, the program content of lease package 32 is determined based on historical use of features to the software program. For example, features used less than a predetermined number of times over a predetermined time period may be classified as inactive features, and as such, are not provided in the program content of the lease package 32.

Security content of lease package 32 may set at least one limit on accessing program content of lease package 32. For example, the security content may be used to set the lease package 32 to expire after a predetermined number of times the program content has been executed, after a predetermined number of days (execution period), or a combination of both. The lease package 32 may be programmed to track the amount of days and/or the number of uses it has been operating. During the execution period, software framework 25 may execute lease package 32. As can be envisioned by a person skilled in the art, to prevent software piracy and/or control access to features of the software program, the software framework 25 may be configured to refrain from executing lease package 32 after it expires or to delete the lease package 32 once the it expires. For example, lease package 32 ceases to respond to commands upon expiration of the execution period or may be programmed to delete itself upon expiration of the execution period. In yet another embodiment, client server 18 may also be configured to delete lease package 32 upon expiration of the execution period. Client server 18 may also be configured to delete any lease package 32 associated with inactive features of the software program.

When the execution period for the lease package 32 expires, a new lease package 32 may be obtained during the retrieval period. In one embodiment, the new lease package 32 provides the same features as the expired lease package 32. In another embodiment, the new lease, package 32 provides improved features over the expired lease package 32. This allows the subscription provider of lease package 32 to periodically update, upgrade, and/or improve lease package 32.

Lease package 32 may be encrypted by public/private encryption methods well known to a person skilled in the art. For example, the remote server 12 may encrypt lease package 32 with a private key specific to the location, IP address, serial number or other identifier that is unique to the client server 18 or the workstation 16. As such, only the client server 18 or the workstation 16 subscribing to an additional feature of the software program can unlock the lease package 32 with the private key. A public key may be included with the lease package 32 to unlock the program content of the lease package 32 and allow the user to read the program content. The public key may be used to date stamp the lease package 32 using, for example, Public Key Infrastructure Time-Stamp Protocol, to provide a reference date and time for the subscription period. In one embodiment, the public key may allow the software framework 25 to read-only the program content, while the private key may allow the software framework 25 to read and write to the encrypted data.

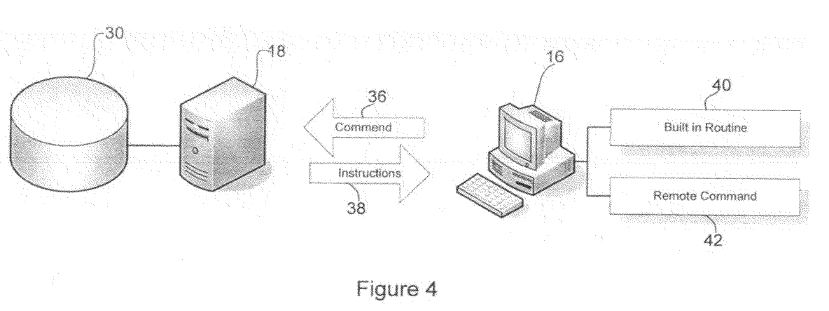

FIG. 4 illustrates the interactions between workstation 16 and client server 18, according to one embodiment of the present invention. As shown in the figure, client server 18 is coupled to the workstation 16 and the client database 30. The client database 30 stores, arranges and retrieves lease package 32. Workstation 16 may be configured to send a command 36 to client server 18 and receive instructions 38 from the client server 18. The command 36 may be directed to a subscribed feature or operation of the lease package 32. In one embodiment, the command 36 may be a remote command 42, such as known commands that the lease package 32 has to execute. The client server 18 retrieves the lease package 32 from the client database 30, executes the command 36, and sends instructions 38 back to workstation 16. The workstation 16 executes the instructions 38 using one or more built-in routines 40.

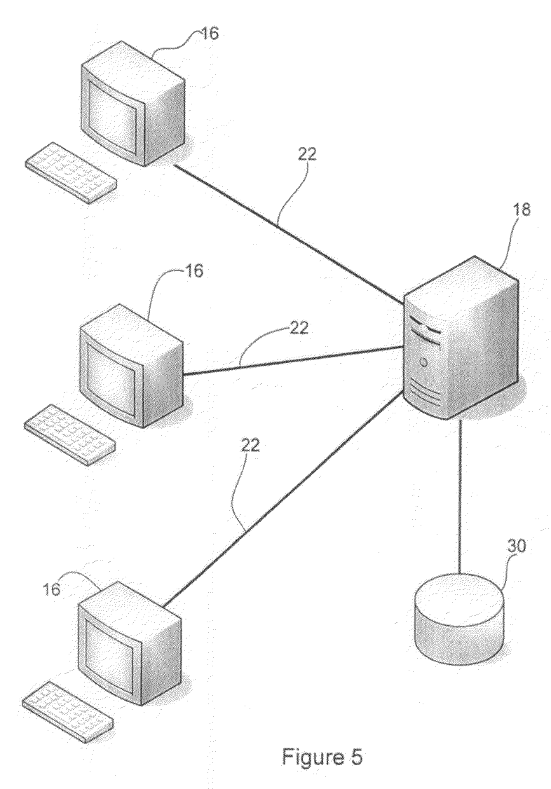

FIG. 5 illustrates client server 18 with a plurality of workstations 16, each workstation 16 having software framework 25 with selectors 26 associated with lease packages 32 in the client database 30. The client server 18 retrieves one or more lease packages 32 from the client database 30, executes commands 36 from workstations 16, and sends instructions 38 back to the workstations 16 via, for example, a client intranet 22. According to one embodiment, lease package 32 may include an update to the software program on the plurality of workstations 16. Rather than update each software program on workstations 16, the software program is updated on the client server 18, which accordingly sends updated instructions 38 back to the workstations 16. For example, a department store having a plurality of workstations 16, need not each have a complete version of the software program; rather, have software framework 25 with selectors 26 associated with lease packages 32. This allows each workstation 16 to access lease packages 32 for only the software features commonly used. Furthermore, this facilitates and improves the process for updating the software program on each workstation 16.

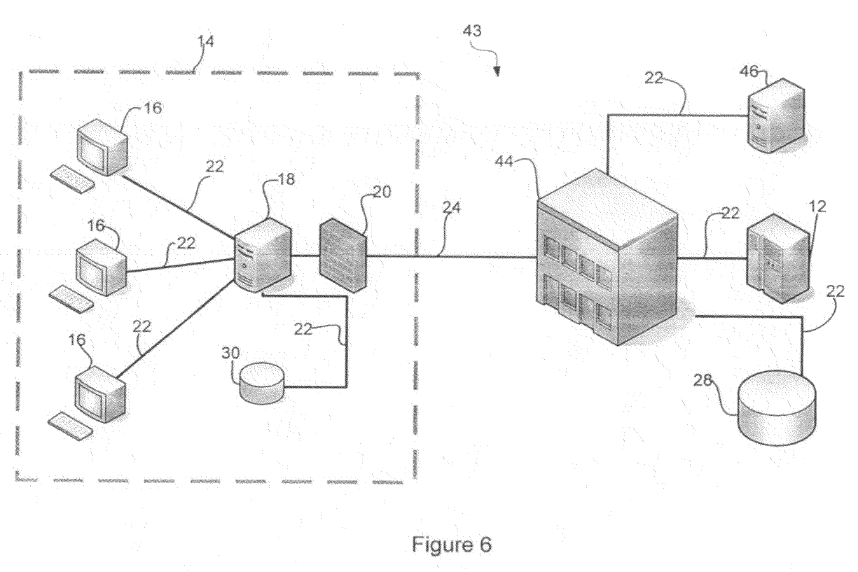

FIG. 6 is an exemplary subscription system 43 for a plurality of workstations 16 according to one embodiment of the present invention. The subscription system 43 may include client system 14, subscription provider 44, client management server 38, remote server 12, and remote database 28. The subscription provider 44 may be a central location where one or more client systems 14 connect to via the network 24. Client management server 38 may be used to enter and manage client information, such as payment plans and client subscription. This information may be stored on the client management server 38 or the remote database 28. In one embodiment, the client management server 38 may be configured to interface with a client-accessible website and/or a program accessible by customer service representatives. Remote server 12 may be configured to receive a request code to access lease package 32, retrieve client information from client management server 38, verify client's subscription status, retrieve lease package 32 from remote database 28 if client paid for subscription, and transmit lease package 32 to client system 14. The client server 18 receives the lease package 32 after passing through firewall 20. Client server 18 may then either store lease package 32 in client database 30 or transmit lease package 32 to at least one workstation 16.

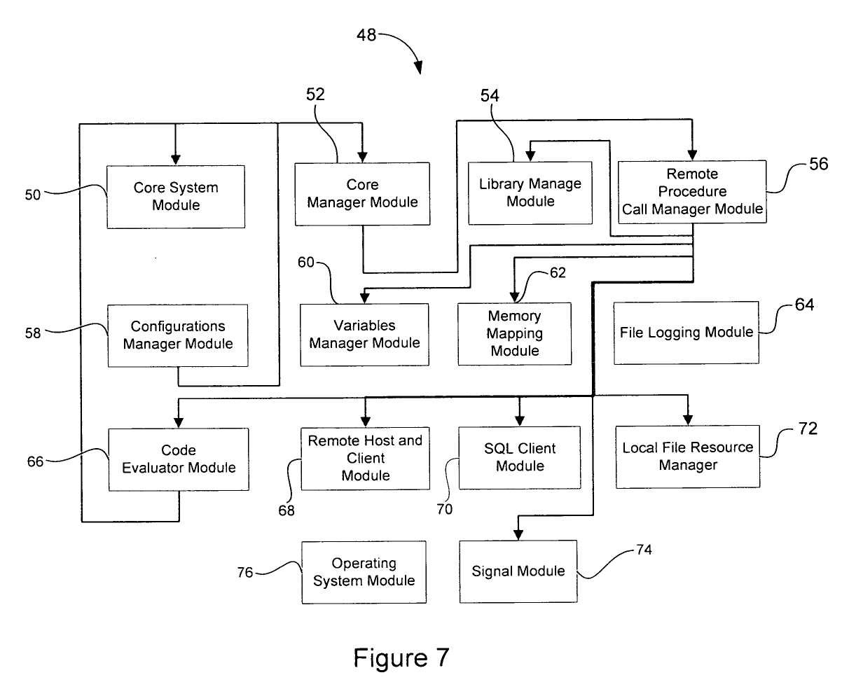

FIG. 7 is a block diagram illustrating a module system 48 for a subscription system, according to one embodiment of the present invention. As shown in FIG. 7, module system 48 may include a plurality of modules, such as, a core system module 50, a core manager module 52, a library manager module 54, a remote procedure call manager module 56, a configuration manager module 58, a variables manager module 60, a memory mapping module 62, a file logging module 64, a code evaluator module 66, a remote host and client module 68, an SQL client module 70, a local file resource manager 72, a signal module 74 and an operating system module 76. It can be envisioned by a person skilled in the art that one or more combinations of these modules may be used, in module system 48, instead of their separate counterparts.

Core system module 50 may be configured to provide access to subscription system settings and functions, to process all commands given to it by the library, and to perform command syntax checking, record command history, error checking, basic routines and other such controlling operations.

Core manager module 52 provides a user interface that facilitates the performance of duties in a certain sequence that would otherwise have to be done manually. Core manager module 52 may be configured to provide control over the system settings stored in configuration manager module 58. The core manager module 52 may be configured to retrieve the system settings from the configuration manager module 58 and execute them. Core manager module 52 may also be configured to actuate remote procedure call manager module 56 to perform various operations, including accessing remote database 28. Remote procedure call manager module 56 may communicate with at least one of library manager module 54, variables manager module 60, memory mapping module 62, code evaluator module 66, remote host and client system module 68, SQL client module 70, local file resource manager 72, signal module 74, and operating system module 76. As such, core manager module 52 may control the operations of the modules communicatively coupled to the remote procedure call manager module 56. For example, core manager module 72 may be configured to start remote host and client system module 68, transmit system commands to the remote procedure call manager module 56, facilitate the execution of remote procedure calls on the remote procedure call manager module 56, or perform SQL queries through the SQL client module 70.

Library manager module 54, may be used to facilitate expanding or updating the core system module 50 without actually replacing the module 50 itself. The library manager module 54 interfaces with the core system module 50 by creating a Dynamic Link Library (DLL) that contains functions that may be called from other executable code in the core system module 50.

Remote procedure call manager module 56 may communicate with at least one of library manager module 54, variables manager module 60, memory mapping module 62, code evaluator module 66, remote host and client system module 68, SQL client module 70, local file resource manager 72, signal module 74, and operating system module 76. According to one embodiment, the remote procedure call manager module 56 may include commands that a client system 14 can execute on remote host and client system module 68. These commands may be used to facilitate security requirements as well as security levels for the client system 14. Once the commands are executed on the remote host and client system module 68, the result may be delivered back to the client system 14 via the remote procedure call manager module 56.

Configuration manager module 58 may be configured to contain information corresponding to the performance of duties, such as the name, location, and port of a server to connect to. The configuration manager module 58 may store startup configuration settings for the core system module 50. In an illustrative embodiment, at least one of core system module 50 and core manager module 52 may reference configuration manager module 58 to determine how remote procedure call manager module 56 causes workstation 16 to connect to remote database 28 or client database 30.

Variables manager module 60 may be configured to store, arrange and retrieve variables, such as temporary commands from the remote procedure call manager module 56. The variables may be stored on an XML file. In one embodiment, the variables manager module 60 stores strings (no objects) on a single level structure with no root keys. In contrast, memory mapping module 62 may utilize root keys to provide temporary memory maps while the software program is executing. The temporary memory maps may be used to store values, objects, or any other data in a “globally” available location. When remote procedure call manager module 56 is being used, memory maps can be shared with different workstations 16 through the remote host and client system module 68, if proper permissions have been granted to a particular memory map root.

File logging module 64 may be used to keep a log of any client system 14 that attempts to access the remote server 12. File logging module 64 keeps record of process information, such as security information or accessing information. File logging module 64 may be used to monitor the activity of any module or operation within module system 48.

Code evaluator module 66 stores and retrieves programming scripts that may be executed in module system 48. In an illustrative embodiment, code evaluator module 66 retrieves a script from a database, such as remote database 28 or client database 30, and causes core system module 50 and/or core manager module 52 to execute the script without making permanent modifications to the library manager module 54.

Remote host and client system module 68 facilitates cross-network communication between the client system 14 and a server, such as client server 18 and/or remote server 12. Remote host and client system module 68 allows the user of workstation 16 to execute an operation on the server. In an illustrative embodiment, remote procedure call manager module 56 causes remote host and client system module 68 to send command 40 to the server for execution. The server executes the command and transmits the result as instruction 42 to remote host and client system module 68, which, in turn, transmits instruction 42 to remote procedure call manager module 56.

SQL client module 70 allows remote procedure call manager module 56 to communicate with an SQL server, query an SQL database, and perform SQL operations.

Local file resource manager 72 may be configured to store and access files from a remote location, such as remote database 28, for use by workstation 16. Examples of files that may be managed by local file resource manager 72 include, but are not limited to, non-executable data files such as pictures and text files. When remote procedure call manager module 56 requests a file stored in a remote location, local file resource manager 72 accesses the file and provides it to remote procedure call manager module 56. In one embodiment, local file resource manager 72 provides a “virtual path” using a Uniform Resource Locator or a Uniform Resource Identifier that allows all file names and file paths to be system independent.

Signal module 74 may include signals/commands that correspond to specific functions in the subscription system. When remote procedure call manager module 56 requests the remote server 12 to perform a specific function, the remote server 12 executes a command from the signal module 74, and returns the result of the function to the remote procedure call manager module 56.

Operating system module 76 may be configured to facilitate access to the operating system of the workstation 16 to perform built-in functions. As an interface, operating system module 76 allows the module system 48 to manipulate certain features of the operating system, such as initiating file transfers and executing other programs.

According to one embodiment, core system module 50, core manager module 52, library manager module 54, and remote procedure call manager module 56 may be used to interface with the remote server 12. Configurations manager module 58, variables manager module 60, memory mapping module 62, and file logging module 64 may be implemented with the software program for support, for example, to provide configurations, variables, temporary variables and information logging. Code evaluator module 66, remote host and client system module 68, SQL client module 70, and local file resource manager 72 may be used to provide the software program with access to resources, such as, access to remote database 28, remote server 12, client server 18, or client database 30. For example, code evaluator module 66 may provide access to scripts, remote host and client module 68 may provide access to network resources, SQL client module 70 may provide access SQL database, and local file resource manager 72 may provide access to files. Signal module 74 and operating system module 76 may be used generally for operating systems functions or defining utility within the software program.

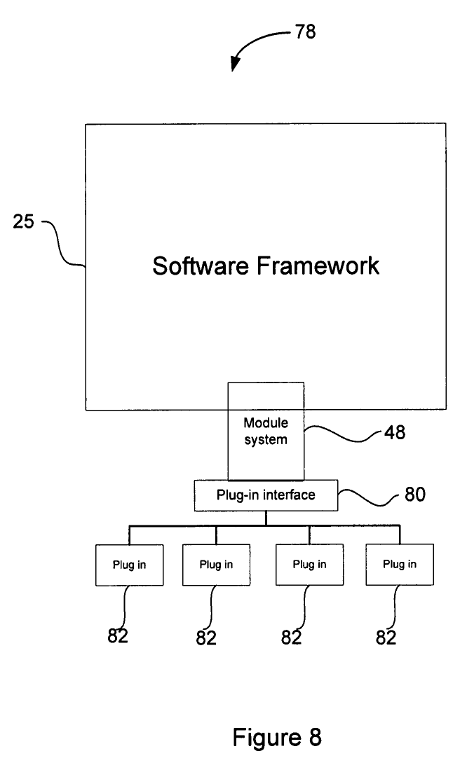

FIG. 8 is a block diagram illustrating components of a software program 78, according to one embodiment of the present invention. The software program 78 may include software framework 25, module system 48, plug-in interface 80, and at least one subscription plug-in 82. Software framework 25 allows a user of workstation 16 to interface with module system 48. In an illustrative embodiment, software framework 25 may actuate module system 48 to execute basic operations without the presence of subscription plug-ins 82. The plug-in interface 80 may be an interface unit such as Performance Application Programming Interface (PAPI). The plug-in interface 80 may be embodied in library manager module 54 to interface the module system 48 with the at least one subscription plug-in 82. The at least one subscription plug-in 82 may be used to provide additional features of the software program 78. Each subscription plug-in 82 may provide one or more operations executable by module system 48 without requiring modifications to software framework 25 or module system 48.

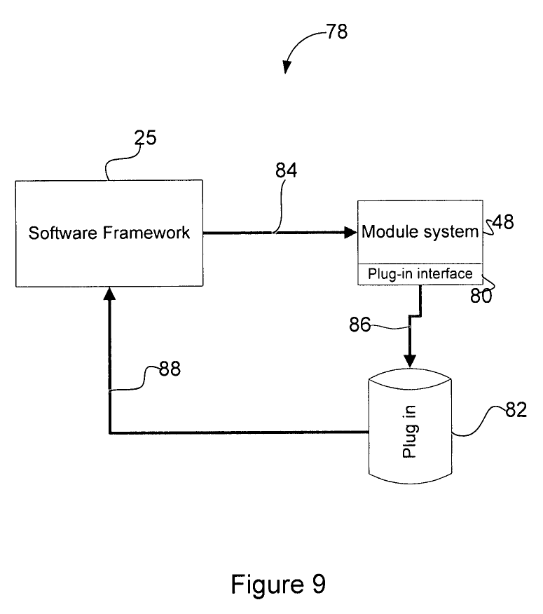

FIG. 9 is a block diagram illustrating a software framework 25 interfacing with subscription plug-in 82, according to one embodiment of the present invention. The software framework 25 may be configured to send a plug-in request 84 to module system 48. The module system 48 actuates the plug-in interface 80 to send a plug-in command or sub-command 86 to subscription plug-in 82 for execution. The subscription plug-in 82 executes the plug-in command 86 and delivers its result as a plug-in response 88 to the software framework 25. In an illustrative embodiment, subscription plug-in 82 may be located on workstation 16, client server 18, remote server 12, remote database 28 or client database 30.

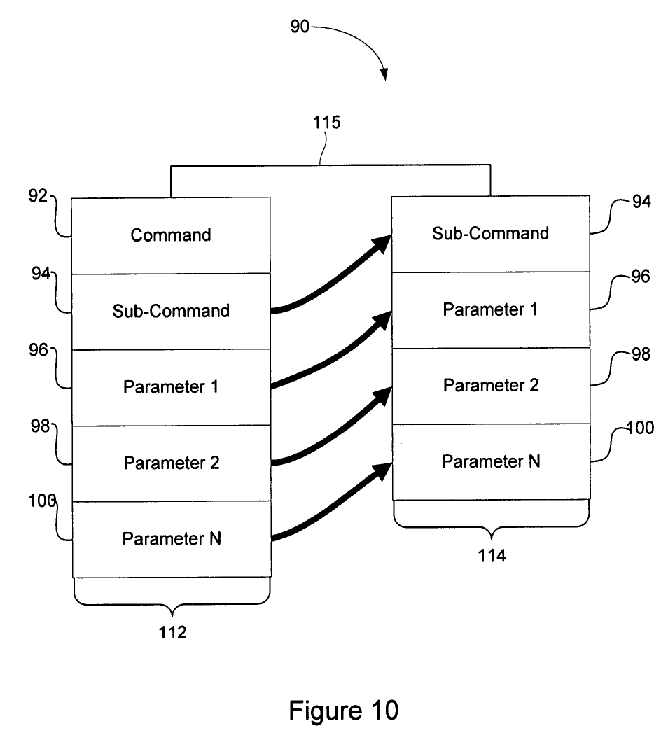

FIG. 10 is a block diagram illustrating a command system 90 for the software program 78, according to one embodiment of the present invention. The command system 90 may be used to execute commands in the software program 78. Command system 90 may include at least one frame, at least one command and at least one parameter. In an, illustrative embodiment, command system 90 may include a first frame 112 with a primary command 92, a sub-command 94, and a first parameter 96. The primary command 92 may be programmed to invoke (115) a second frame 114 for execution. For example, primary command 92 may be used to identify and route the sub-command 94 and the first parameter 96 to the second frame 114 for execution. Once the second frame 114 is identified and/or invoked, sub-command 94 and first parameter 96 of the first frame 112 are stored in the second frame 114. In the second frame 114, sub-command 94 is executed according to the first parameter 96. In one embodiment, the first frame 112 may include a plurality of parameters 96, 98 and 100 that are routed to the second frame 114. Each parameter 96, 98 and 100 are stored in the second frame 114 and are used for executing the sub-command 94.

In one embodiment, sub-command 94 in the second frame 114 may be programmed to invoke a third frame (not shown) for execution. Similarly, the third frame (not shown) may invoke a fourth frame (not shown), until ultimately the command is completely executed. In another embodiment, the first frame 112 may include additional sub-commands, each with its own parameters. Primary command 92 may be programmed to invoke an additional frame for each additional sub-command and its respective parameters. Each sub-command may then be executed in a separate frame (not shown).

In one embodiment, command system 90 may be used by the software framework 25 to interact with module system 48. Command, system 90 may also be used by the library manager module 54, code evaluator module 66, remote host and client system module 68, local file resource manager 72, and/or signal module 74 to communicate with remote server 12 or client server 18. Command system 90 may be used to send and execute command 40 on remote server 12 or client server 18, as shown in FIG. 4. Primary command 92 of first frame 112 may be executed on workstation 16 and may invoke second frame 114 on remote server 12 or client server 18. Sub-command 94 may be executed on remote server 12 or client server 18 according to parameters 96, 98 and 100. Second frame 114, operated on remote server 12 or client server 18, may also contain a sub-command that invokes a new frame on workstation 16 and executes an additional sub-command on workstation 16.

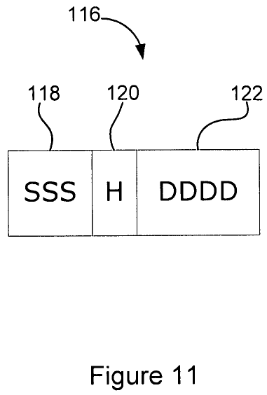

FIG. 11 illustrates a command syntax 116 for the software program 78, according to one embodiment of the present invention. The command syntax 116 may include a system code identifier 118, a harmony code identifier 120, and a command code identifier 122. System code identifier 118 may be used to identify a module in the module system 48 where primary command 92 or sub-command 94 is executed.

Where multiple versions of individual modules exist in module system 48, harmony code identifier 120 may be used to identify which version of the module specified by system code 118 should be utilized to execute primary command 92 or sub-command 94. In an illustrative embodiment, a module that receives and executes an incoming command with a given harmony code identifier 120 must assign the same harmony code identifier 120 to a subsequent outgoing command that is based upon the result of the execution of the incoming command. In an illustrative embodiment, primary command 92 or sub-command 94 is backwards compatible with versions prior to the version specified in harmony code identifier 120.

Command code identifier 122 may be used to identify the specific command to be executed in the subscription system 10. For example, the command code identifier 122 may be used to identify a specific command code in a reference table for execution. Such a reference may also indicate parameters and other prerequisites required for execution of primary command 92 or sub-command 94.

While certain exemplary embodiments have been described and shown in the accompanying, drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. For example, any combination which performs a functionally analogous task as servers 12, 18 is understood within the scope of the specification to be included within the definition of the server. Likewise, artisans understand that for the purpose of the instant disclosure, the servers 12, 18 may include any number of serially linked units performing these functions within the scope of this invention.

As can be envisioned by a person skilled in the art, the invention allows a programmer to remove components out of his or her software and place these items into a lease package. The lease package, when delivered will provide the programmer's application the missing puzzle pieces that will allow the software program to work. In one embodiment, the system and method for controlling access to features of the software program may be used for a business application that may have a database accessing routines and business logic operations stored in the lease package. The system and method for controlling access to features of the software program may also be used for a game application that may have level data and loading procedures stored in the lease package. The lease package may be a self-contained library of software services or features containing self-defense mechanisms like self destruction and encryption.

Those skilled in the art will appreciate that various adaptations and modifications of the just described preferred embodiments may be configured without departing from the scope and spirit of the invention. Therefore, it is to be understood that, within the scope of the appended claims, the invention may be practiced other than as specifically described herein.

1. A system for controlling access to features of a software program on a workstation, the software program having a software framework with at least one selector that is configured to access a lease package associated therewith when selected, the lease package is accessible during a subscription period, the system comprising:
a server communicatively coupled to the workstation, the server having a processor for: receiving a request code to access the lease package for the at least one selector, determining a subscription status for the lease package, and providing the software framework with access to the lease package if the request code to access the lease package is within the subscription period, otherwise, denying access to the lease package.

2. The system of claim 1, wherein the lease package comprises at least one subscription plug-in.

3. The system of claim 1, wherein the subscription period is a retrieval period to retrieve the lease package.

4. The system of claim 1, wherein the subscription period is an execution period to execute the lease package.

5. The system of claim 1, wherein the server is a client server.

6. The system of claim 1, wherein the server is a remote server.

7. A method for controlling access to features of a software program, comprising:
receiving a request code to access a lease package for at least one selector of a software framework, the at least one selector is configured to access the lease package associated therewith when selected, the lease package is accessible during a subscription period;
determining subscription status for the lease package; and
providing the software framework with access to the lease package if the request code to access the lease package is within the subscription period, otherwise, denying access to the lease package.

8. The method of claim 7, wherein the lease package comprises at least one subscription plug-in.

9. The method of claim 7, wherein the subscription period is a retrieval period to retrieve the lease package.

10. The method of claim 7, wherein the subscription period is an execution period to execute the lease package.

11. The method of claim 7, wherein the server is a client server.

12. The method of claim 7, wherein the server is a remote server.

13. A machine-readable medium that provides instructions for a software framework with a plurality of selectors, which when read by a processor, cause the machine to perform operations comprising:
sending, to a remote server, a request code to access a lease package for one of the plurality of selectors; and
receiving, from the remote server, access to the lease package, if the request code to access the lease package is within the subscription period, otherwise, denying access to the lease package,
wherein the plurality of selectors are adapted to access a lease package associated therewith when selected, and
wherein the lease package is accessible during a subscription period.

14. The machine-readable medium of claim 13 further comprising interfacing the lease package with the software framework for execution.

15. The machine-readable medium of claim 13, wherein sending a request code to access a lease package actuates a module system selected from a group consisting of a core system module, a core manager module, a library manager module, a remote procedure call manager module, a configuration manager module, a variables manager module, a memory mapping module, a file logging module, a code evaluator module, a remote host and client module, an SQL client module, a local file local file resource manager, a signal module and an operating system module.

16. The machine-readable medium of claim 13, wherein the module system actuates an interface unit to send a command for execution of a lease package.

17. The machine-readable medium of claim 13, wherein the lease package comprises at least one subscription plug-in.

18. The machine-readable medium of claim 13, wherein the subscription period is a retrieval period to retrieve the lease package.

19. The machine-readable medium of claim 13, wherein the subscription period is an execution period to execute the lease package.
